(19) United States
(12) Patent Application Publication
(10) Pub. No.: US 2004/0137950 A1
(43) Pub. Date: Jul. 15, 2004

(54) Built-in, multi band, multi antenna system

(76) Inventors: Thomas Bolin, Lund (SE); Zhinong Ying, Lund (SE); Johan Andersson, Malmo (SE); Andre Da Silva Frazao, Malmo (SE); Peter Nordenstrom, Skanor (SE)

Correspondence Address: Stanley R Moore, Jennkens & Gilchrist, Suite 3200, 1445 Ross Avenue, Dallas, TX, 75202-2799, US

(21) Appl. No.: 10/472,996

(22) PCT Filed: Mar. 20, 2002
(86) PCT No.: PCT/SE02/00532

(30) Foreign Application Priority Data
Mar. 23, 2001 (SE) 0101067-7
Apr. 25, 2001 (US) 60286412
Jun. 20, 2001 (SE) 0102183-1

(51) Int. Cl. H04M 1/00

(52) U.S. Cl. 455/562.1

(57) ABSTRACT

A build-in, multi band, multi antenna system (1) for a protable communicaiton device (10) has a first antenna (2, 4, 5), which is resonant in first an second frequency band. A secon antenna (3) is resonant in a fourth frequency bank. The first antenna, the papasitic element and the second antenna are provided on a common flexible substrate.

### TECHNICAL FIELD

The present invention relates to mobile telephones and similar types of portable communication devices that need several commercial frequency bands to communicate on. More specifically, the invention relates to a built-in, multi band, multi antenna system for such mobile telephones, etc.

### BACKGROUND ART

A basic problem of today is to be able to put one or several very small antennas on e.g. a mobile telephone. Main emphasis is put on size, but a good electrical performance is also important. Now when Bluetooth™ applications have become a world standard, an additional frequency band must be covered in future mobile telephones. It is very hard to include this in an already existing antenna, most commonly a built-in antenna. Another way is to include a new antenna to handle Bluetooth™ communication. Usually the available space is very small—in fact, too small in reality. The antennas will often have to be located very close to each other, since generally, the best position is at the top of the telephone.

This kind of complicated internal antenna system needs a very sophisticated mechanical process, involving for example MID, metal painting and printed film. The designer must be very careful to get good isolation between the main antenna and the Bluetooth™ antenna.

State of the art today is one single antenna, usually a built-in patch antenna with one grounding and one feeding pin, functioning at two commercial frequency bands: GSM and DCS or maybe GSM and PCS. No Bluetooth™ antenna has been observed on the market together with such an antenna in a mobile telephone.

Thus, the known antennas are only dual band, and a Bluetooth™ antenna is not included.

### SUMMARY OF THE INVENTION

It is an object of the present invention to propose a very compact multi band, multi antenna system, with a cheap and sophisticated mechanical concept to get good isolation by clever design of a parasitic element as a high impedance block.

The object of the invention is achieved by an antenna system according to the attached independent patent claim.

Other objects, features and advantages of the present invention will appear from the following detailed disclosure of a preferred embodiment, from the enclosed drawings as well as from the subclaims.

### BRIEF DESCRIPTION OF THE DRAWINGS

A presently preferred exemplifying embodiment of an antenna system according to the present invention will now be described in more detail with reference to the accompanying drawings, where:

FIG. 1 is a schematic perspective view of the antenna system,

FIG. 2 is schematic side view of the antenna system shown in FIG. 1,

FIG. 3 is a schematic perspective view of a mobile telephone with an antenna carrier and an antenna connector for the antenna system of FIGS. 1 and 2,

FIG. 4 corresponds to FIG. 3, with the addition of the antenna system of FIGS. 1 and 2 in an unfolded condition,

FIG. 5 shows the unfolded antenna system of FIG. 4 together with the antenna connector mounted on a printed circuit board,

FIG. 6 is a return loss diagram for a main antenna and a Bluetooth™ antenna, which are comprised in the antenna system,

FIG. 7 illustrates the isolation between the two antennas of FIG. 6,

FIG. 8 is a dimensioned drawing of the presently preferred embodiment of the antenna system, and

FIGS. 9-12 are alternative embodiments of the antenna system according to the invention.

### DETAILED DISCLOSURE

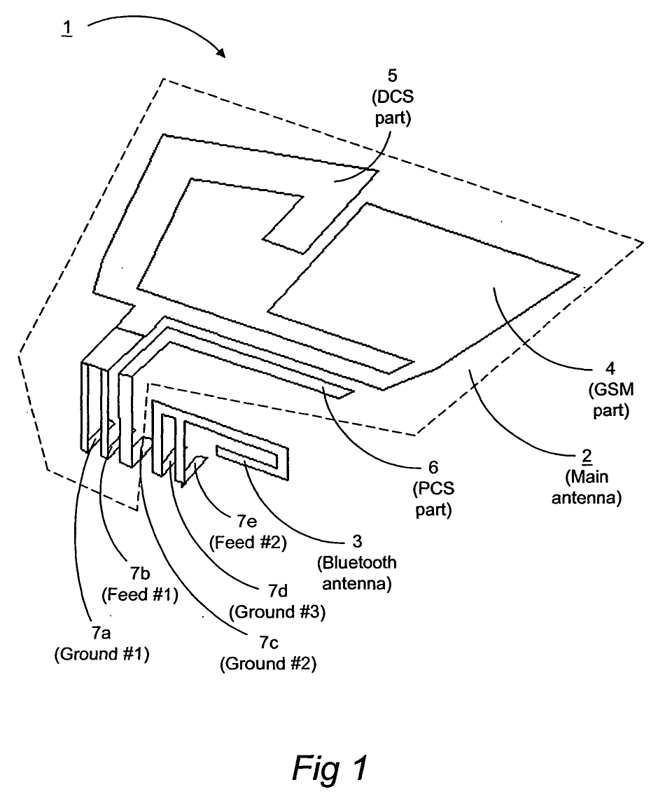

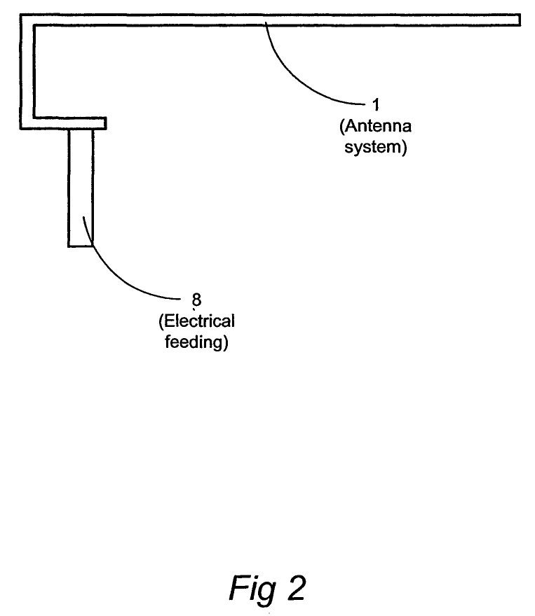

A simplified illustration of the antenna system 1 according to the invention is given in FIGS. 1 and 2. The antenna system has a main antenna 2 for GSM/DCS/PCS and a separate smaller Bluetooth™ antenna 3 positioned very close to the main antenna 2. As seen in FIG. 2, the antennas have a folded distribution which occupies a first plane where most of the antenna pattern is located, a second plane which is perpendicular to the first plane, and a third plane which is perpendicular to the second plane and parallel to the first plane.

The main antenna 2 is a built-in patch with parasitic element, whereas the smaller Bluetooth™ antenna 3 is a PIFA, however folded a little bit to fit the small space available. The combination of the antennas, their individual positions, and the folding together with the electrical connection are noteworthy features.

A significant advantage with the antenna system according to the present invention is the size reduction that obtained by placing the antennas close together as well as the folding of the antenna patterns.

The main antenna 2 comprises a dual band PIFA antenna with a GMS part 4 and a DCS part 5. In addition, the main antenna 2 comprises a parasitic PCS part 6. The main antenna 2 and the Bluetooth™ PIFA antenna 3 are printed on the same flexible substrate (not shown in the drawings) and constitute a common flex film.

The metal trace of the parasitic PCS part 6 is located between the main antenna 2 and the Bluetooth™ antenna 3. It is resonant at PCS 1900 MHz, about ¼ wavelength, and will function as a high impedance blocking between the main antenna 2 and the Bluetooth™ antenna 3.

By arranging the antennas in this manner, it is possible to reduce the overall size of the antenna system compared to if the parasitic element was not present. As can be understood, moving the antennas further apart, which would be necessary in the absence of the parasitic element, would increase the isolation between the main antenna and the Bluetooth™ antenna.

The antenna system 1 has five connection traces 7a-7e, which all are located in the third plane. Of these connection traces, the main antenna 2 has a ground trace 7a (“Ground #1”) and a feed trace 7b (“Feed #1”) for the GSM part 4 and the DCS part 5. The parasitic PCS part 6 has only a ground trace 7c (“Ground #2”), whereas the Bluetooth™ antenna 3 has a ground trace 7d (“Ground #3) as well as a feed trace 7e (“Feed #2”), as shown in FIG. 1. The actual width of the feed traces is a tradeoff between size and performance. By widening the feed traces, a better performance would be achieved. However, wider feed traces result in an increased size of the antenna system.

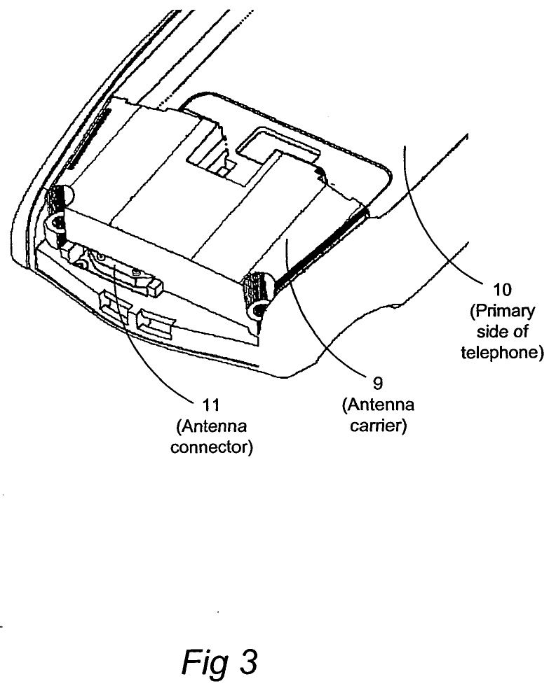

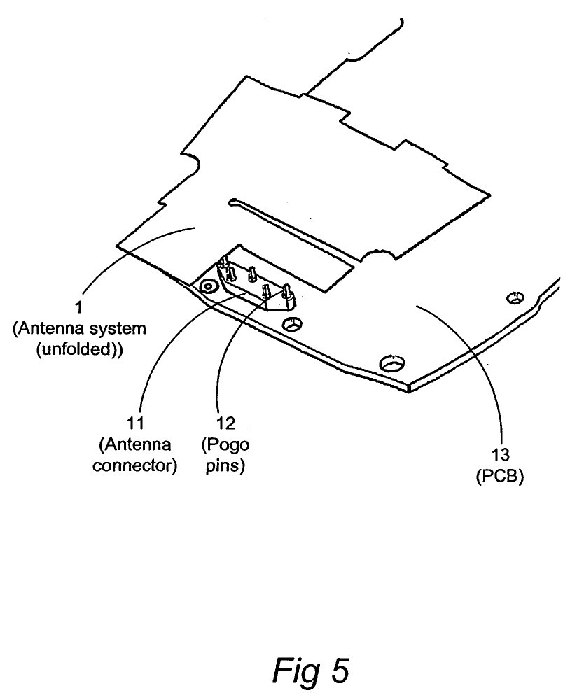

As seen in FIG. 2, the antenna system 1 is connected to radio circuitry on a printed circuit board 13 (FIG. 5) through electrical feeding 8. As appears from FIGS. 3-5, the electrical feeding 8 is implemented as an antenna connector 11, which is mounted to the printed circuit board 13 and comprises a group of five pogo pins 12 (one for each connection trace 7a-7e).

In a preferred embodiment, the flex film with the antenna system 1 is placed on a plastic antenna carrier 9, which will keep the film at its correct position with respect to the printed circuit board 13. FIG. 3 illustrates the antenna carrier 9 together with the antenna connector 11 and the primary side of a mobile telephone 10.

The material used for the antenna carrier will affect the antenna performance. This is due to that the antenna carrier will act as a dielectric loading, changing the resonance frequencies of the antennas slightly. A lossy material, i.e. a material with a large dielectric constant, will give a better VSWR (Voltage Standing Wave Ratio) and hence a broader bandwidth, but will at the same time provide a lower antenna gain. As mentioned above, in the preferred embodiment the antenna carrier is made of plastic. However, other materials such as ceramic, mica, or glass could also be used as carrier material, depending on the desired working characteristics of the antenna system.

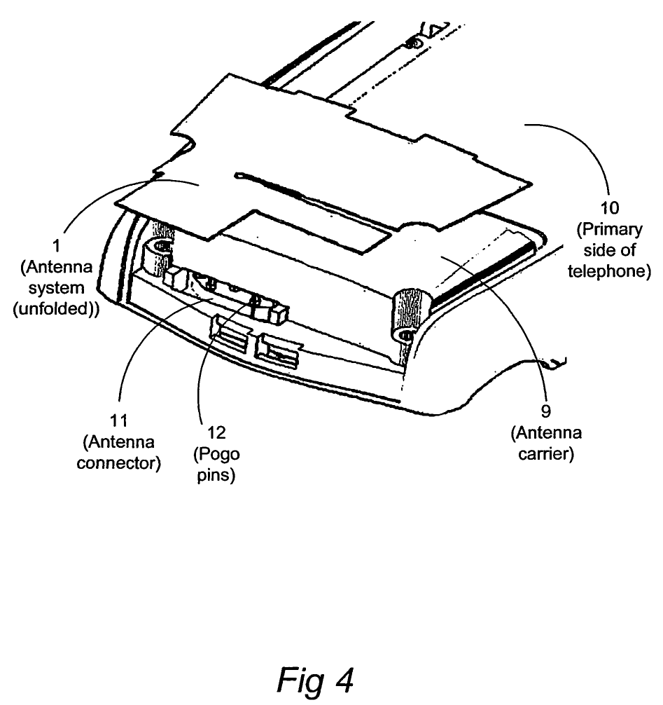

FIG. 4 illustrates the base of the antenna system 1 unfolded in one plane above the antenna carrier 9. The antenna connector 11 with its pogo pins 12 is shown underneath the antenna carrier 9.

FIG. 5 illustrates, again, the antenna system 1 unfolded above the antenna connector 11 and the pogo pins 12. The naked printed circuit board 13 is also shown.

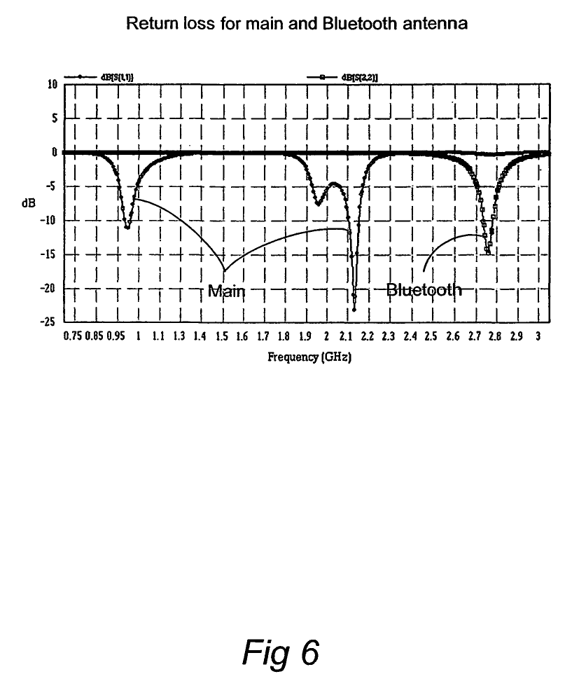

FIG. 6 shows return loss for the main antenna 2 and the Bluetooth™ antenna 3. As seen, the antennas are tuned (designed) to work at slightly too high frequencies. This is done in order to compensate for losses that are introduced by the plastic cover and the rest of the mechanics underneath.

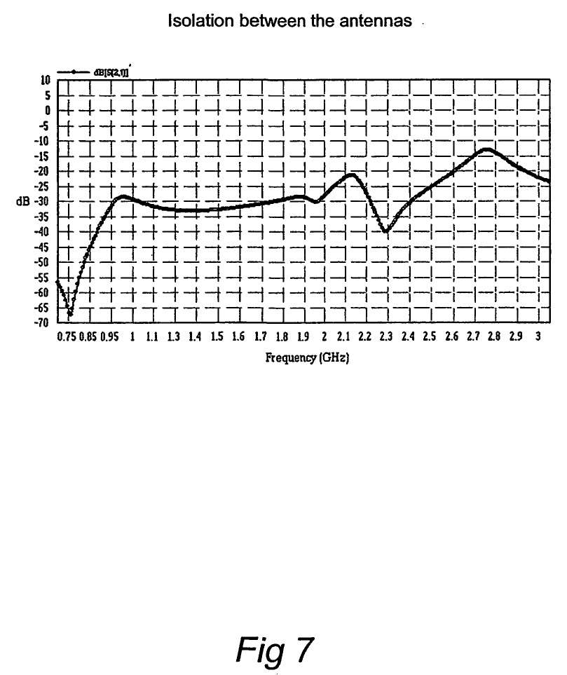

FIG. 7 illustrates the isolation between the two antennas of FIG. 6. Obviously, the isolation is very good, even in the highest band despite the short distance between the antennas.

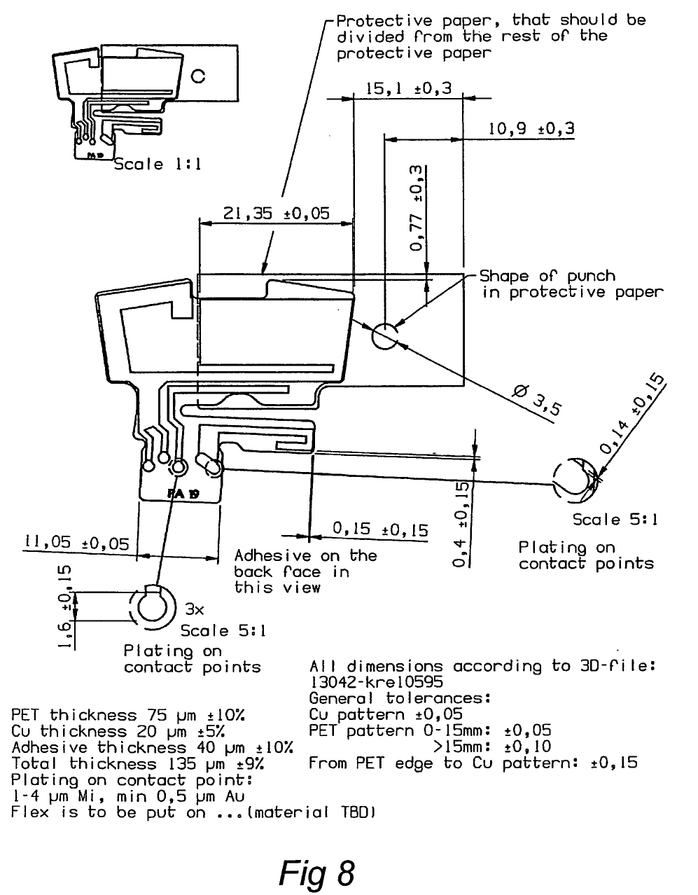

FIG. 8 is a dimensioned drawing of the presently preferred embodiment of the antenna system.

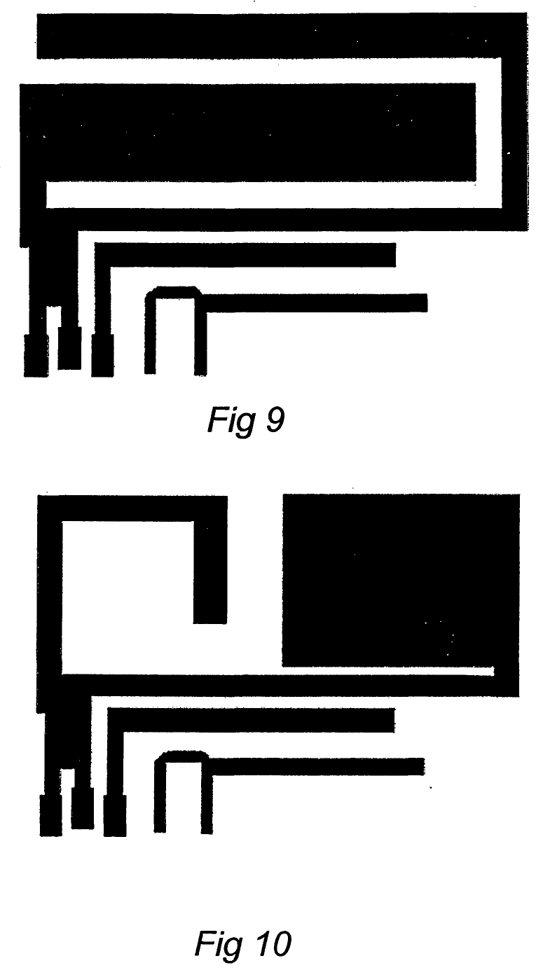

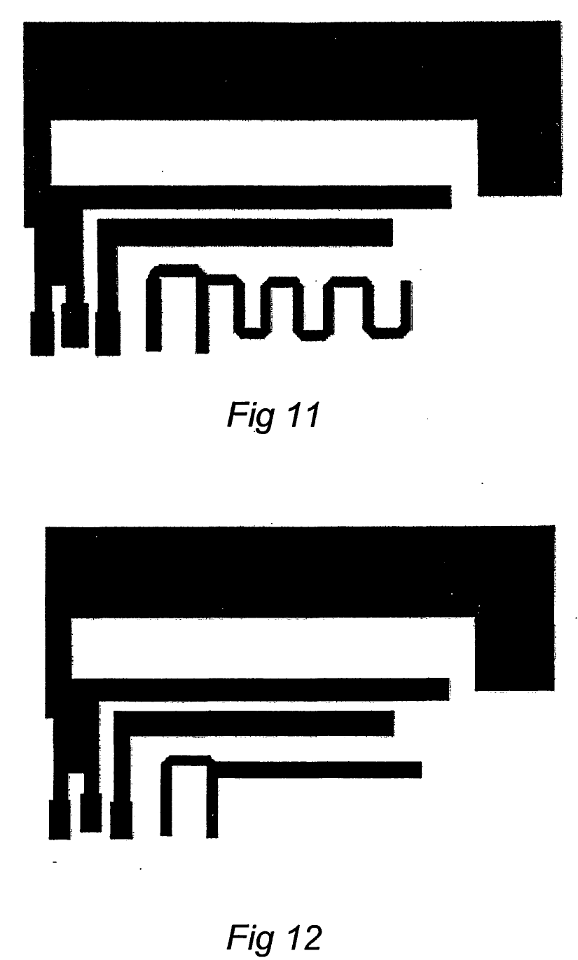

Finally, FIGS. 9-12 illustrates four alternative embodiments of the antenna system according to the invention. As can be seen from the figures different parts of the antenna system may look different depending on e.g. the amount of space available inside the portable communication device.

The invention has been described above with reference to a presently preferred embodiment example. However, other embodiments than the one described above as well as many modifications, variations and equivalent arrangements are possible within the scope of the invention, as defined by the appended independent patent claim.

1. A built-in, multi band, multi antenna system (1) for a portable communication device (10), comprising, in combination:
a first antenna (2, 4, 5), which is resonant in first and second frequency bands,
a parasitic element (6), which is positioned adjacent to the first antenna and is resonant in a third frequency band, and
a second antenna (3), which is resonant in a fourth frequency band,
wherein the first antenna, the parasitic element and the second antenna are provided on a common flexible substrate.

2. An antenna system as in claim 1, wherein the first antenna (2, 4, 5) and the second antenna (3) are PIFA antennas.

3. An antenna system as in claim 2, wherein
the first antenna (2, 4, 5) has a first feed trace (7b) and a first ground trace (7a),
the parasitic element (6) has a second ground trace (7c), and
the second antenna (3) has a second feed trace (7e) and a third ground trace (7d).

4. An antenna system as in claim 3, wherein
the first antenna (2, 4, 5) has a GSM part (4) and a DCS part (5),
the parasitic element (6) is operative in the PCS band, and
the second antenna (3) is a Bluetooth™ antenna.

5. An antenna system as in any preceding claim, wherein the parasitic element (6) is located between the first antenna (2, 4, 5) and the second antenna (3) so as to provide high impedance blocking between the antennas.

6. An antenna system as in any preceding claim, further comprising an antenna carrier (9), upon which said common flexible substrate is provided in a folded distribution.

7. A portable communication device (10) having a printed circuit board (13), characterized by
an antenna system (1) according to any of claims 1-6, and
an antenna connector (11) for connecting the antenna system to the printed circuit board (13).

8. A portable communication device as in claim 7, the antenna system (1) being defined by claim 3, wherein the antenna connector (11) comprises a group of five pogo pins (12), each of which is aligned with a respective one of said first feed trace (7b), said first ground trace (7a), said second ground trace (7c), said second feed trace (7e) and said third ground trace (7d).

9. A portable communication device as in claim 7 or 8, wherein the device is a mobile telephone.
